(19) United States
(12) Patent Application Publication
(10) Pub. No.: US 2015/0224664 A1
(43) Pub. Date: Aug. 13, 2015

(54) CUTTER ASSEMBLY

(71) Applicant: Glassline Corporation, Perrysburg, OH (US)

(72) Inventors: John Harkness, Bowling Green, OH (US); John K. Clement, JR., Toledo, OH (US)

(21) Appl. No.: 14/621,463

(22) Filed: Feb. 13, 2015

Related U.S. Application Data
(60) Provisional application No. 61/939,320, filed on Feb. 13, 2014.

(51) Int. Cl. B26D 3/26; A47J 25/00; B26D 1/00

(52) U.S. Cl. CPC B26D 3/26; B26D 1/0006; A47J 25/00; B26D 2001/0033; B26D 2001/004

(57) ABSTRACT

A cutting assembly includes a core tube. A plurality of blades extends radially outwardly from and is releasably supported by the core tube. The cutting assembly also includes a support member and a sealing member. The support member releasably supports a portion of each of the plurality of blades. The sealing member has a first substantially planar surface cooperating with the support member to secure the portion of each of the plurality of blades intermediate the support member and the first substantially planar surface of the sealing member.

### CROSS-REFERENCE TO RELATED APPLICATIONS

This application claims the benefit of U.S. Provisional Application No. 61/939,320, filed on Feb. 13, 2014. The entire disclosure of the above application is hereby incorporated herein by reference.

### FIELD OF THE INVENTION

The present disclosure relates to a cutter assembly, and more particularly, to a cutter assembly having individually replaceable blades.

### BACKGROUND OF THE INVENTION

The statements in this section merely provide background information related to the present disclosure and may not constitute prior art.

As commonly known in the art, apparatuses exist for cutting food products. Certain apparatuses for cutting food products incorporate varying cutter assemblies to perform varying cutting functions such as decoring and cutting food products into wedges and/or slices. The food product can be manually or automatically fed through the cutter assemblies of the apparatuses to produce the cut food product. The cutter assemblies typically include an array of blades and/or a core tube coupled thereto.

Eventually, after continuing use of the cutter assemblies, the blades may begin to dull, crack, fatigue, or bend and maintenance may require replacement of the entire array of blades. However, in many circumstances, maintenance may require replacement of less than the entire array of blades such as when a single blade has become dulled or cracked, for example. Furthermore, depending on the type of desired food product and the desired size or type of cut, it may be desired to have a cutter assembly that has varying blade arrangements for varying food products and varying sizes and types of cut. Therefore, it is advantageous to have a cutter assembly with individually replaceable blades and core tube so the blades and/or core can be easily and individually replaced and arranged.

Certain apparatuses known in the art include replaceable blades. For example, in U.S. Pat. No. 7,073,260 a knife assembly for use in a food cutting apparatus is disclosed. The assembly includes a cylindrical core knife, a plurality of knife blades, a blade support member, a base ring, and a compression ring. The blade support member receives the knife blades. The compression ring engages with the blade support member and base ring by a taper compression feature to secure the knife blades in the longitudinal slots of the core knife. However, these cutting assemblies with replaceable blades are complex and expensive to manufacture.

Accordingly, there is a continuing need for a cutter assembly that is simple to assemble and inexpensive to manufacture. It would be advantageous if a cutter assembly for a cutting tool could be improved.

### SUMMARY OF THE INVENTION

In accordance and attuned with the instant disclosure, improvements for a cutter assembly that is simple to assemble and inexpensive to manufacture have surprisingly been discovered.

According to an embodiment of the disclosure, a cutting assembly is disclosed. The cutting assembly includes a core tube and a plurality of blades extending radially outwardly from the core tube. The plurality of blades are releasably supported by the core tube. The cutting assembly also includes a support member and a sealing member. The support member releasably supports a portion of each of the plurality of blades. The sealing member has a first substantially planar surface cooperating with the support member to secure the portion of each of the plurality of blades intermediate the support member and the first substantially planar surface of the sealing member.

According to another embodiment of the disclosure, a cutting assembly is disclosed. The cutting assembly includes a core tube having a first end, a second end, and a cutting edge formed at the first end. A plurality of blades extend radially outwardly from and are releasably supported by the core tube. Each of the plurality of blades has a first end and a second end. The cutting assembly further includes a support member and a sealing member. The support member has a plurality of notches formed in a surface thereof. Each of the plurality of notches receive and support a portion of one of the plurality of blades. The surface opposes the second end of the core tube. The sealing member cooperates with the support member to secure the portions of the plurality of blades within the notches of the support member.

According to yet another embodiment of the disclosure, a cutting assembly is disclosed. The cutting assembly includes a core tube having a first end, a second end, and a cutting edge formed at the first end. A plurality of blades extend radially outwardly from and are releasably supported by the core tube. Each of the plurality of blades have a first end and a second end. The cutting assembly further includes a support member and a sealing member. The support member has a plurality of notches formed therein. Each of the plurality of notches receives and supports a portion of one of the plurality of blades. The sealing member cooperates with the support member to secure the portions of the plurality of blades within the notches of the support member. The support member is disposed intermediate the second end of the core tube and the sealing member.

Further areas of applicability will become apparent from the description provided herein. It should be understood that the description and specific examples are intended for purposes of illustration only and are not intended to limit the scope of the present disclosure.

### DRAWINGS AND ADDITIONAL MATERIALS

The above, as well as other advantages of the present invention, will become readily apparent to those skilled in the art from the following detailed description of a preferred embodiment when considered in the light of the accompanying drawings in which:

FIG. 1 is top perspective view of a cutter assembly;

FIG. 2 is an exploded top perspective view of the cutter assembly of FIG. 1;

FIG. 3 is a front elevational view of the cutter assembly of FIG. 1; and

FIG. 4 is a cross-sectional view taken along the line 4-4 of FIG. 3.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

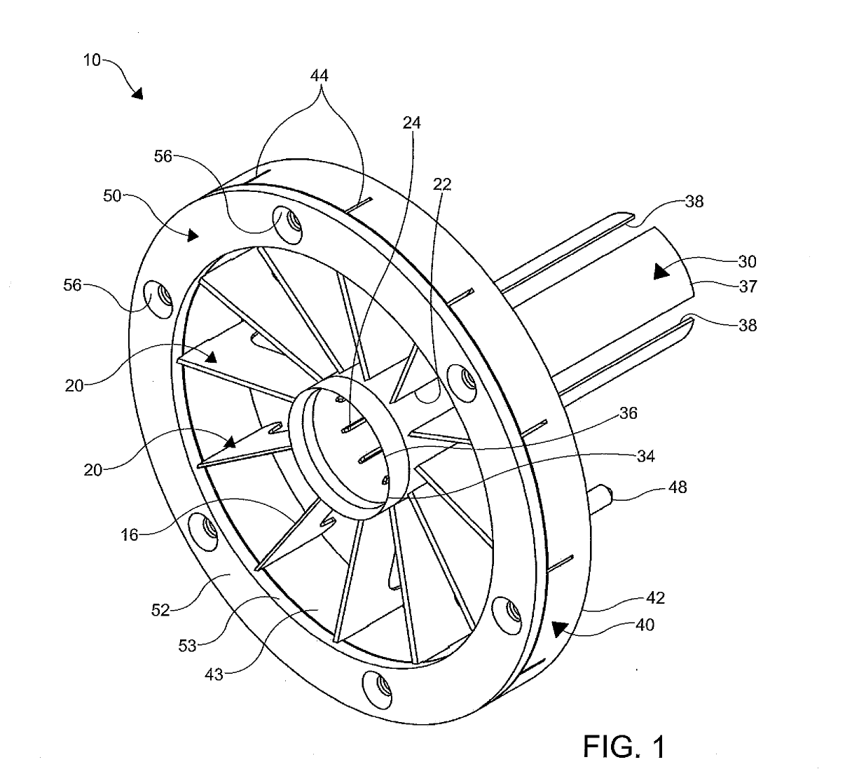

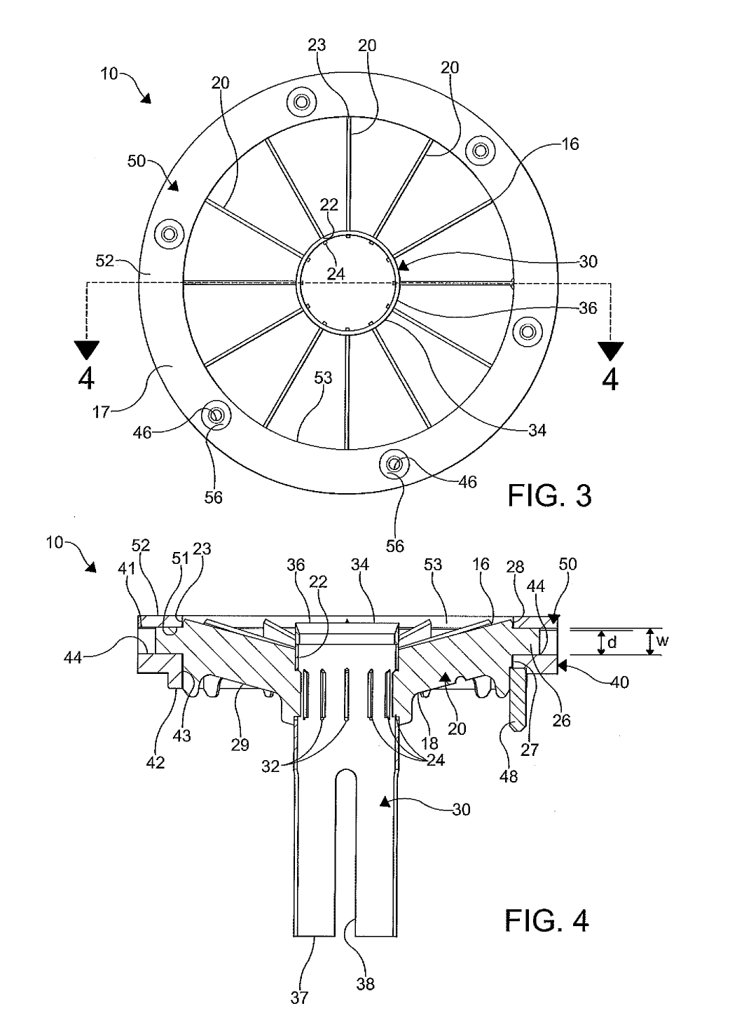

In FIGS. 1-4, there is illustrated a cutter assembly 10 for cutting and decoring a food product according to an embodiment of the invention. The cutter assembly 10 is configured for use with a manual or automatic food cutting apparatus (not shown) for slicing, cutting, wedging, and coring the food product fed therethrough. The cutter assembly 10 includes a plurality of blades 20, a core tube 30, a support member 40, and a sealing member 50.

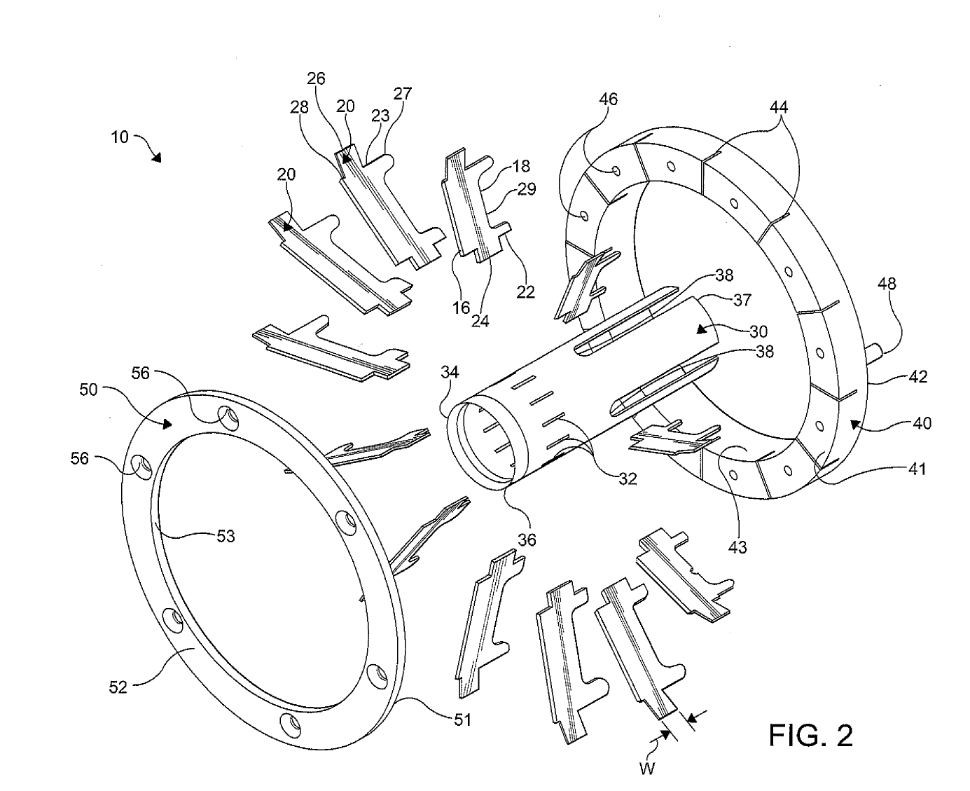

As shown in FIG. 2, each of the blades 20 includes a cutting edge 16 configured for cutting the food product and a trailing edge 18 opposing the cutting edge 16. Each of the blades 20 further includes a first end 22 opposing a second end 23. Each of the blades 20 includes a protuberance 24 extending outwardly from the first end 22 thereof and a tab 26 extending outwardly from the second end 23 thereof. At the second end 23, a first shoulder 27 is formed adjacent the tab 26 and the trailing edge 18 and a second shoulder 28 is formed adjacent the tab 26 and the cutting edge 16 of each of the blades 20. As shown, the protuberance 24 and the tab 26 have a substantially rectangular shape. However, it is understood the protuberance 24 and the tab 26 can have any shape such as triangular, ovular, circular, or any other shape as desired, for example. In certain embodiments, each of the blades 20 includes an indentation 29 formed in the trailing edge 18 thereof. The indentation 29 is configured to facilitate handling of the blades 20.

With renewed reference to FIGS. 1-4, the blades 20 are supported by the core tube 30. The core tube 30 is substantially cylindrical and includes a first end 36 and a second end 37. A cutting edge 34 is formed at the first end 36 thereof and is configured to cut the food product such as decoring the food product, for example. The core tube 34 includes an annular array of spaced-apart longitudinal slots 32 formed therein for receiving the protuberances 24 of the blades 20 to support the blades 20. Each of the protuberances 24 is inserted into the slots 32 so the first end 22 of the blades 20 abuts an outer surface of the core tube 30. Once inserted into the slots 32, the blades 20 extend radially outwardly from the core tube 30. In certain embodiments, a plurality of recesses 38 are formed in a second end 37 of the core tube 30. The plurality of recesses 38 is configured to facilitate coupling the core tube 30 to the food cutting apparatus.

In the embodiment illustrated, the cutter assembly 10 includes twelve blades 20 for cutting the food product into twelve separate wedges and twelve corresponding slots 32 formed in the core tube 30. However, the cutter assembly 10 can include any number of blades 20 and/or slots 32, as desired, such as more than twelve or fewer than twelve. Additionally, in the embodiment illustrated, each of the blades 20 aligns with and opposes another one of the blades 20. However, each of the blades 20 can also be misaligned from the other blades 20, if desired.

The support member 40 is an annular ring and includes a first substantially planar surface 41 substantially parallel to and opposing a second substantially planar surface 42 thereof. An annular array of spaced apart notches 44 is formed in the first surface 41 thereof. Each of the notches 44 is configured to receive the tabs 26 of the blades 20. Adjacent notches 44 are spaced apart from each other at a distance corresponding to a distance between the second end 23 of adjacent blades 20 extending from the core tube 30. In certain embodiments, each of the notches 44 has a depth less than a width w of the tabs 26 of each of the blades 20, wherein a portion of each of the tabs 26 extends a minimal distance from the first surface 41 of the support member 40. In the embodiment illustrated, the support member 40 includes twelve notches 44 formed therein to correspond to the number of the blades 20 of the cutter assembly 10. However, it is understood the support member 40 can include any number of notches 44, as desired, such as more than or fewer than 12.

A plurality of apertures 46 for receiving an attachment means (not shown) is formed in the first surface 41 of the support member 40. As illustrated, the support member 40 includes twelve apertures 46 interposed between the notches 44. However, the support member 40 can include any number of apertures 46 formed at any location in the first surface 41 of the support member 40. The support member 40 further includes a positioning pin 48 disposed on the second surface 42 thereof and extending outwardly therefrom. The positioning pin 48 facilitates a positioning of the cutter assembly 10 in a desired position with respect to the food cutting apparatus.

The sealing member 50 is an annular ring and includes a first substantially planar surface 51 substantially parallel to and opposing a second substantially planar surface 52 thereof. The sealing member 50 has an inner wall 53 having a diameter substantially equal to a diameter of the inner wall 43 of the support member 40. The sealing member 50 has a plurality of apertures 56 formed therethrough for receiving the attachment means. Each of the apertures 56 of the sealing member 50 corresponds to and is aligned with one of the apertures 46 of the support member 40. In a non-limiting example, as illustrated, the sealing member 50 has six apertures 56 formed therein. However, the sealing member 50 can have any number of apertures 56 formed therein such as twelve apertures or any number more than or fewer than six apertures.

The sealing member 50 is releasably coupled to the support member 40 by the attachment means to releasably secure the plurality of blades 20 to the support member 40. The attachment means can be any attachment means such as fasteners, bolts, pins, or the like for example that can be inserted through each of the apertures 46, 56 to releasably couple the sealing member 50 to the support member 40. However, it is understood other attachment means can be employed to couple the sealing member 50 to the support member 40 as desired, such as clamps, retaining rings, clasps, and the like for example without departing from the scope of the disclosure.

The first surface 51 of the sealing member 50 faces the first surface 41 of the support member 40. As shown in FIG. 4, each of the tabs 26 of the blades 20 is positioned and secured between the first surface 51 of the sealing member 50 and the support member 40. Each of the tabs 26 of the blades 20 is received in the notches 44 so that the first shoulder 27 of the blades 20 abuts the inner wall 43 of the support member 40 and the second shoulder 28 abuts the inner wall 53 of the sealing member 50.

In the embodiment illustrated in FIG. 4, the cutting edge 34 of the core tube 30 is slightly receded from a position planar with the second surface 52 of the sealing member 50. The blades 20 are configured so that the cutting edge 16 of each of the blades 20 tapers from the inner wall 53 of the sealing member 50 towards a portion of the core tube 30 intermediate the cutting edge 34 of the core tube 30 and the slots 32 of the core tube 30. However, the blades 20 can be configured so that the cutting edge 34 of the core tube 30 is substantially perpendicular to the inner wall 53 of the sealing member 50 or tapers from the core tube 30 towards the inner wall 53 of the sealing member 50, as desired.

To assemble the cutter assembly 10, the protuberances 24 of the blades 20 are inserted into the slots 32 of the core tube 30 so that the blades 20 extend radially outwardly from the core tube 30. The tabs 26 of the blades 20 are inserted into the corresponding notches 44 of the support member 40 so that the second shoulders 27 of the blades 20 abut the inner wall 43 of the support member 40 and the second shoulders 28 of the blades 20 abut the inner wall 53 of the sealing member 50. The sealing member 50 is coupled to the support member 40 with the attachment means so the first surface 41 of the support member 40 faces the first surface 51 of the sealing member 50 and opposed the second end 37 of the core tube 30 to secure the blades 20 to the support member 40. The tabs 26 are positioned between the first surface 41 of the support member 40 and the first surface 51 of the sealing member 50 When coupled to each other, the sealing member 50 is in alignment with the support member 40 so that the respective inner walls 43, 53 thereof align with each other and each of the apertures 56 of the sealing member 50 aligns with one of the apertures 46 of the support member 40 to receive the attachment means therein.

When the sealing member 50 is coupled to the support member 40, the first surface 51 of the sealing member 50 engages with the portion of the tabs 26 extending minimally outwardly from the first surface 41 of the support member 40. Accordingly, the first surface 51 of the sealing member 50 imparts a force against the tabs 26 of the blades 20 into the notches 44 thereby securing the blades 20 and the core tube 30 within the support member 40. The core tube 30 is positioned within the support member 40 wherein the second end 37 thereof extends outwardly at a distance from the second surface 42 of the support member 40.

Once assembled, the cutter assembly 10 is positioned within the food cutting apparatus. The positioning pin 48 facilitates alignment of the cutter assembly 10 in a desired position with respect to the food cutting apparatus. The cutter assembly 10 cooperates with the cutting apparatus to cut and decore fruit and vegetable food products such as tomatoes, oranges, onions, or apples, for example. However, the cutter assembly 10 could be used to cut any other food products, as desired. As individual blades 20 or the core tube 30 become dull or damaged, the dulled or damaged blades 20 and/or the core tube 30 can be individually replaced. To replace the individual blades 20 and/or core tube 30, the sealing member 50 is removed from the support member 40 and the dull or damaged blade 20 and/or the core tube 30 is removed. An undamaged or undulled alternate one of the blades 20 and/or the core tube 30 can then be installed.

Advantageously, the cutter assembly 10 facilitates replacement of the blades 20 and/or the core tube 30 individually without having to replace all of the blades 20 and the core tube 30. The cutter assembly 10 can be efficiently and ergonomically assembled and disassembled. The cutter assembly 10 contains minimal parts to minimize costs of manufacturing and complexity of assembly while maintaining durability and effectivity thereof.

While certain representative embodiments and details have been shown for purposes of illustrating the invention, it will be apparent to those skilled in the art that various changes may be made without departing from the scope of the disclosure, which is further described in the following appended claims.

What is claimed is:

1. A cutting assembly, comprising:
a core tube;
a plurality of blades extending radially outwardly from and releasably supported by the core tube;
a support member releasably supporting a portion of each of the plurality of blades; and
a sealing member having a first substantially planar surface cooperating with the support member to secure the portion of each of the plurality of blades intermediate the support member and the first substantially planar surface of the sealing member.

2. The cutting assembly of claim 1, wherein the support member and the sealing member are annular rings.

3. The cutting assembly of claim 1, wherein the portion of each of the plurality of blades is a radial outward portion of each of the plurality of blades.

4. The cutting assembly of claim 1, wherein the support member includes a plurality of notches formed therein for receiving the portion of each of the plurality of blades.

5. The cutting assembly of claim 1, wherein each of the plurality of blades includes a cutting edge opposing a trailing edge and a first end opposing a second end.

6. The cutting assembly of claim 5, wherein each of the plurality of blades includes a protuberance extending outwardly from the first end thereof.

7. The cutting assembly of claim 6, wherein the core tube includes an annular array of spaced apart longitudinal slots receiving the protuberances of the plurality of blades.

8. The cutting assembly of claim 5, wherein each of the plurality of blades includes a tab extending outwardly from the second end thereof.

9. The cutting assembly of claim 8, wherein the support member includes a plurality of notches formed therein, the plurality of notches receiving the tabs of the plurality of blades.

10. The cutting assembly of claim 9, wherein a depth of each of the notches is less than a width of each of the tabs.

11. The cutting assembly of claim 6, wherein each of the plurality of blades includes a shoulder formed at the first end thereof, the shoulder of each of the plurality of blades abutting at least one of an inner wall of the support member and an inner wall of the sealing member.

12. A cutting assembly, comprising:
a core tube having a first end, a second end, and a cutting edge formed at the first end;
a plurality of blades extending radially outwardly from and releasably supported by the core tub, each of the plurality of blades having a first end and a second end;
a support member having a plurality of notches formed in a surface thereof, each of the plurality of notches receiving and supporting a portion of one of the plurality of blades, the surface opposing the second end of the core tube; and
a sealing member cooperating with the support member to secure the portions of the plurality of blades within the notches of the support member.

13. The cutting assembly of claim 12, wherein the support member and the sealing member are annular rings.

14. The cutting assembly of claim 12, wherein each of the plurality of blades includes a protuberance extending outwardly from the first end thereof and a tab extending outwardly from the second end thereof, each of the protuberances engaging with the core tube and each of tabs received in one of the plurality of notches.

15. The cutting assembly of claim 14, wherein a depth of each of the notches is less than a width of each of the tabs.

16. The cutting assembly of claim 12, wherein a shoulder is formed at the second end of each of the plurality of blades, each of the shoulders abutting an inner wall of at least one of the support member and the sealing member.

17. A cutting assembly, comprising:
a core tube having a first end, a second end, and a cutting edge formed at the first end;
a plurality of blades extending radially outwardly from and releasably supported by the core tube, each of the plurality of blades having a first end and a second end;
a support member having a plurality of notches formed therein, each of the plurality of notches receiving and supporting a portion of one of the plurality of blades; and
a sealing member cooperating with the support member to secure the portions of the plurality of blades within the notches of the support member, the support member disposed intermediate the second end of the core tube and the sealing member.

18. The cutting assembly of claim 17, wherein the support member and the sealing member are annular rings.

19. The cutting assembly of claim 17, wherein each of the plurality of blades includes a protuberance extending outwardly from the first end thereof and a tab extending outwardly from the second end thereof, each of the protuberances engaging with the core tube and each of tabs received in one of the plurality of notches.

20. The cutting assembly of claim 19, wherein a depth of each of the notches is less than a width of each of the tabs.
